(19) United States
(12) Patent Application Publication
(10) Pub. No.: US 2019/0226634 A1
(43) Pub. Date: Jul. 25, 2019

(54) STEEL STRAP SECURING DEVICE

(71) Applicant: Marmon/Keystone LLC, Bolingbrook, IL (US)

(72) Inventors: Ronald Caris, Toledo, OH (US); Daniel W. Ellis, Buford, GA (US)

(21) Appl. No.: 16/255,222

(22) Filed: Jan. 23, 2019

Related U.S. Application Data
(60) Provisional application No. 62/620,681, filed on Jan. 23, 2018.

(51) Int. Cl. F16M 13/00

(52) U.S. Cl. CPC F16M 13/00

(57) ABSTRACT

A device to secure and restrain ends of a steel strap positioned and tensioned around a load when the strap is cut includes a body having at least one magnet loosely mounted thereto. The body can include a non-linear shape that defines first and second legs opposing each other, and two magnets such that each of the magnets is loosely mounted on respective legs for movement independent of each other. The body can define a mounting plate to which a magnet is loosely mounted on one side with a handle mounted on an opposite side of the plate. The magnet or magnets are free floating and can swivel in varying directions so as to attach to the strap at varying angles and maintain a secure hold on the strap.

### CROSS-REFERENCE TO RELATED APPLICATION DATA

This application claims the benefit of and priority to Provisional U.S. Patent Application Ser. No. 62/620,681, filed Jan. 23, 2018, titled “Steel Strap Securing Device”, the disclosure of which is incorporated herein in its entirety.

### BACKGROUND

Steel strap is a high tensile strength packaging material formed as a band that is used for heavy-duty bundling or securing of loads. In a typical operation, the steel band is positioned and tensioned around the objects to be strapped, and overlying courses of the strap are sealed, such as by crimp seals, interlocking keys cut into the strap and the like. In order to remove the strap, it is often severed or cut using strapping cutters. Because the strap is under tension, when it is cut, the tension is released and the strap to return to its original, relatively straight shape. That is, the strap springs back.

This can be challenging as cutting the strap can cause the severed ends to recoil and spring loose. As such, cutting the strap often requires that the strap be held down against the load with one hand while cutting with the other hand. However, when long handled cutters are used to maintain a desired distance from the line of the cut, using one hand to hold down the strap is not an option. This may then require more than one worker to cut the strap in order to control the loosened ends.

Accordingly, there is a need for a device that allows for securing the strap when it is cut. Desirably, such a device provides an enhancement in securing both ends of the cut strap so that they can be controlled from springing loose. More desirably still, such a device allows a single user to hold down and effectively cut the strap without the assistance of others.

### SUMMARY

Various embodiments of the present disclosure provide a device that secures and restrains the free ends of a steel strap with one or more magnets to allow the tensioned steel strap to be cut and the free ends controlled after the cut.

In an embodiment, a device to secure and restrain ends of a steel strap positioned and tensioned around a load when the strap is cut includes a body having a non-linear shape that defines first and second legs opposing each other. First and second magnets are mounted to the respective first and second legs at about ends thereof. Each of the magnets is loosely mounted on their respective legs for movement independent of each other. The body can include slotted openings on each leg such that the magnets move along the slotted openings.

In an embodiment, a stud is mounted to each magnet. The studs are positioned in respective slotted openings to permit the magnets to move along the slotted openings to allow the magnets to move or swivel, but be secured to the body. The studs can be threaded and the device can include nuts threaded on the studs to loosely secure the magnets to the tool body.

The body can have a horseshoe or omega-like shape to allow the body to flex to absorb the energy from the strap as tension is released.

In an embodiment, a device to secure and restrain ends of a steel strap positioned and tensioned around a load when the strap is cut includes a mounting plate, a magnet loosely mounted to a side of the mounting plate and a handle positioned on an opposite side of the mounting plate.

A stud can be mounted to the magnet. The passes through the mounting plate and is secure on an opposite side of the mounting plate. The handle can be used to mount or secure the stud to loosely secure the magnet to the mounting plate. In an embodiment, the magnet is free floating relative to the mounting plate.

In each embodiment, magnet is or the or magnets are free floating or swiveling so that the device can be attached to the steel strap at a wide variety of angles and can secured the strap on any size or shape load.

These and other features and advantages of the present disclosure will be apparent from the following detailed description, in conjunction with the appended claims.

### BRIEF DESCRIPTION OF THE DRAWINGS

FIG. 1 is a perspective illustration of an embodiment of a steel strap securing device;

FIG. 2 is an illustration showing the device being attached to the steel strap on a load;

FIG. 3 is another illustration showing the device being attached to the steel strap on a different shaped load;

FIG. 4 is an illustration of the device of FIGS. 1-3 shown attached to the strap on a load prior to the strap being cut;

FIG. 5 is an illustration of the device of FIGS. 1-3 shown attached to the strap on a load and after the strap is cut and in which the device secures the free ends of the strap;

FIG. 6 is an exploded illustration of an alternate embodiment of the device, illustrating the free floating magnet, mounting plate and handling knob;

FIG. 7 is an illustration of the embodiment of FIG. 6 showing the device secured to a cutter;

FIG. 8 is an illustration of the device secured to a cutter prior to use;

FIG. 9 is an illustration of the device secured to the band on the load in use;

FIG. 10 is an illustration of the device and the strap, following the strap being cut; and

FIG. 11 is an illustration of a known strap cutter.

### DETAILED DESCRIPTION

While the present disclosure is susceptible of embodiments in various forms, there is shown in the drawings and will hereinafter be described presently preferred embodiments with the understanding that the present disclosure is to be considered exemplifications and are not intended to limit the disclosures to the specific embodiments illustrated.

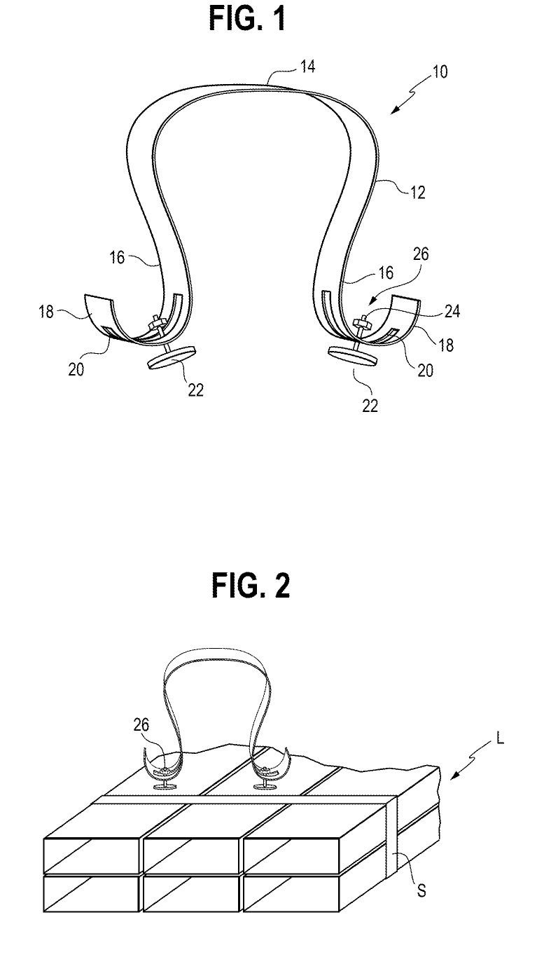

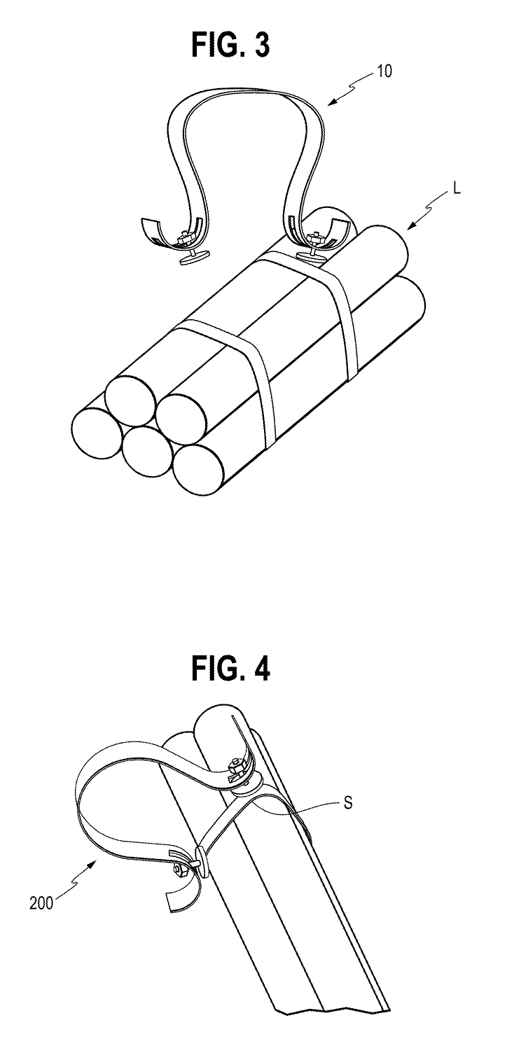

Referring now to the figures and in particular to FIGS. 1-5 there is shown an embodiment of a device 10 to secure and restrain the end E of a strap S, such as steel strap, that is positioned and tensioned around a load L, when the strap S is cut. For purposes of the present disclosure, as will be recognized by those skilled in the art, a wide variety of loads L can be bundled with steel strap S. The strap S is formed as a band and is typically stored in coils prior to use. The strap S tends to straighten or revert to a loosely coiled shape when not under tension. As such, the strap may spring when tension is relieved, as when the strap is cut. The loads L are typically in a wide variety of sizes and shapes. For example, steel members, such as, structural members, pipe and the like are secured by steel strap S.

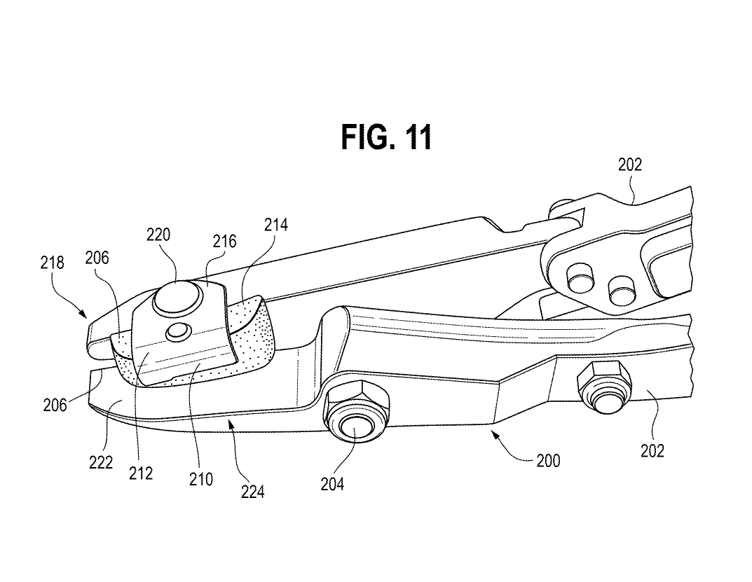

To cut the strap S, a substantially conventional cutter 200 is used, the illustrated cutter 200 being modified as described in more detail herein. One typical cutter 200 is illustrated in FIG. 11 and includes a scissor-like arrangement with a pair of members 202 mounted to one another at a pivot 204. One end of each member includes a cutting blade 206 and the opposing end of each member is a handle 208.

Referring again to FIGS. 1-5, an embodiment of the device 10 has a non-linear body 12, such as the illustrated horseshoe-like or omega-like shape having a curved central portion 14 and first and second legs 16. The body 12 can be formed from a metal, such as steel with the ends 18 spaced from each other. The horseshoe or omega-like body 12 shape allows the body 12 to flex to absorb the energy from the strap S when the strap S is cut, releasing the tension in the strap S. The legs 16 have slotted openings or tracks 20.

Magnets 22 are mounted to the legs 16 at the slotted openings 20 in a loosely mounted arrangement. That is, the magnets 22 are secured to the body 12, so as to move along and swivel freely within the openings or tracks 20 independent of each other. This arrangement permits the body 12, with assembled magnets 22, to be attached to the steel strap S at any required angle for any size or shape load L.

In a present embodiment, the magnets 22 are mounted to studs 24 that are positioned through the slotted openings 20 and loosely secured to the body 12 by fasteners 26. For example, the studs 24 can be threaded rods or bolts and the magnets 22 can be secured by nuts 28 threaded onto the studs 24 to mount the magnets 22 to the body 12. The magnets 22 are sufficiently strong so that they can hold on to the strap S when tension is relieved in the strap S, as after the strap S is cut.

It will be appreciated that when the device 10 is secured to the steel strap S, the magnets 22 are free floating and can swivel in varying directions and move along the openings 20 so as to attach to the strap S at varying angles and maintain a secure hold on the strap S before, during and after the strap S is cut.

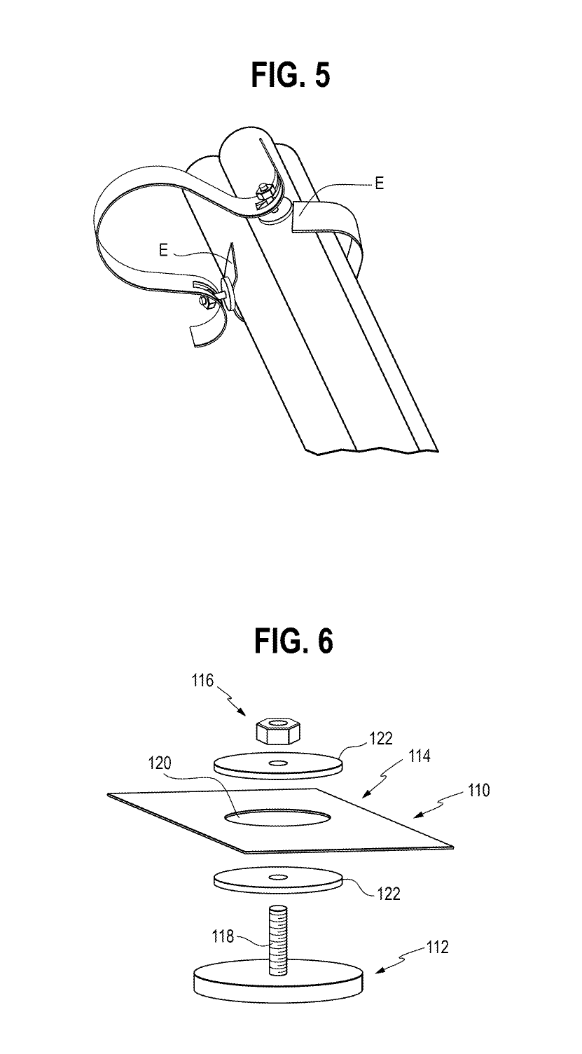

As seen in the illustration of FIG. 4, which shows the strap S prior to being cut, because the magnets 22 are allowed to move along the slotted openings 20 they are positioned with a greater surface area on the strap S. As such, when the strap S is cut, as seen in FIG. 5, the magnets 22 hold the free ends E of the strap S, while the body 12 flexes slightly to accommodate the “spring” in the now cut and untensioned strap S.

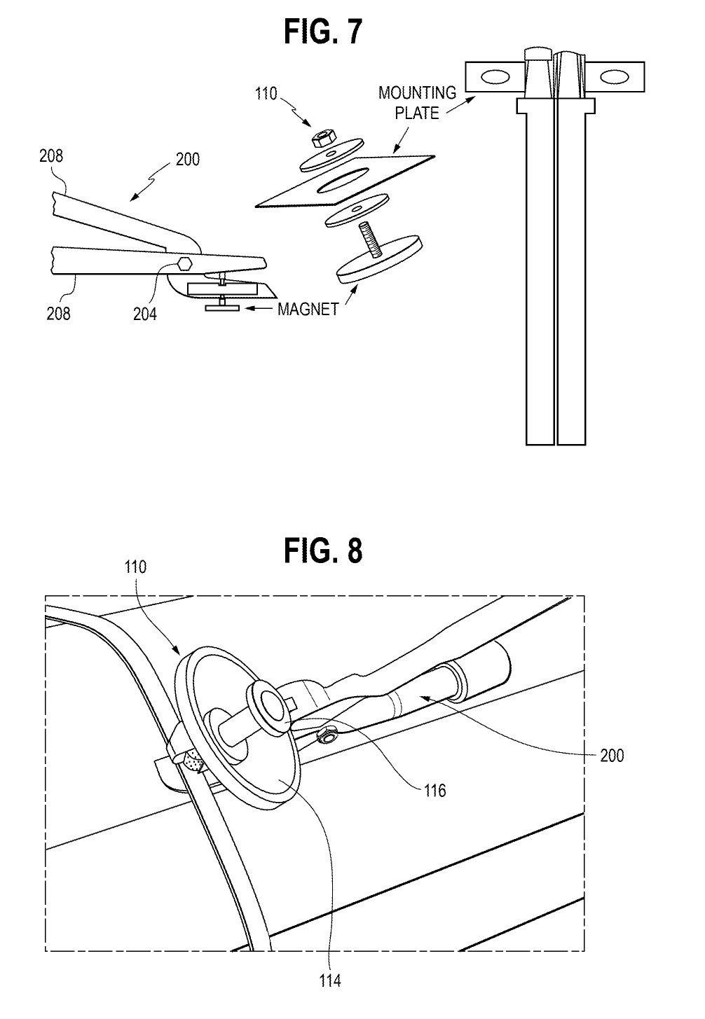

Referring now to the figures and in particular to FIGS. 6-11 there is shown another embodiment of a device 110 to secure a strap end E, such as steel strap S, that is positioned and tensioned around a load L, before, during and after the strap S is cut.

This embodiment includes, generally, a free floating magnet 112, a mounting plate 114, and a handle 116, such as the illustrated knob. The magnet 112 can be mounted to a stud 118 that is positioned through an opening 120 in the mounting plate 114 and the handle 116 can be mounted to the stud 118. In an embodiment, washer-like plates 122 are positioned on the stud 118, on either side of the mounting plate 114. The stud 118 can be, for example a threaded rod or bolt and the handle 116 be threadedly secured to the stud 118. The magnet 112 (and the handle 116) are loosely mounted to the mounting plate 114 to, again, permit the device 110, with assembled magnet 112, to be attached to the steel strap S at any required angle or for any size or shape load L.

It will be appreciated that this embodiment of the device 110 is intended to be used with a cutter 200 such as that illustrated in FIG. 11. In an embodiment the cutter 200 has been modified to include, in an embodiment, a clamp 210, such as the illustrated angle 212 and block 214 that secures one end of the strap S after is it cut, leaving the other end E1 free. The block 214 is formed from a hard resilient material, such as a hard rubber. One leg 216 of the angle 212 is fastened to one of the jaws 218 of the cutter 210, by, for example a screw or bolt 220. The block 214 is secured to the angle 212 and is sized and positioned such that it contacts and bears up against the strap S as the strap S is cut, thus securing one cut end of the strap S between the block 214 and a surface 222 of the opposite jaw 224. Those skilled in the art will recognize the size and position of the block 214 as well as the materials from which the block 214 can be formed. The block 214 need be sufficiently resilient so that it compresses as the jaws 218, 224 are closed onto and cut the strap S, but sufficiently hard so as to restrain the cut strap S end E after the cut is made.

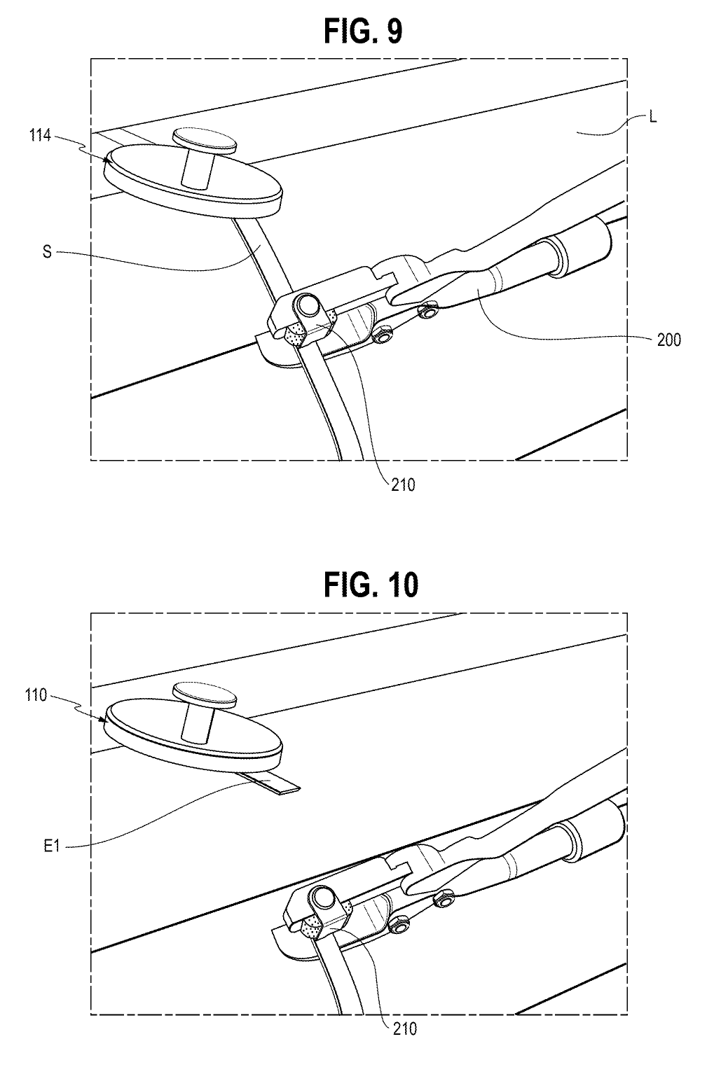

As such, in use, referring to FIGS. 8-10, the device 110 can be secured to the cutter 200 when not in use (to prevent loss of the device 110), as seen in FIG. 8. The cutter 200 is then positioned on the strap S, the device 110 is moved onto the strap S and the load L as seen in FIG. 9, and the strap S is cut. As seen in FIG. 10, the magnet 112 secures the free end E1 of the strap S against the load L, while the other end E of the cut strap S is secured by the cutter clamp 210.

It will be understood from a study of the figures that the present device 10, 110, 200 can be configured to be held in the hand such that a minimal amount of space is required beyond the boundaries of the magnets 22, 112. That is, in the embodiment of FIGS. 1-5, the ends 18 of the horseshoe shaped body 12, and in the embodiment of FIGS. 6-11, the surface area of the mounting plate 114 can be configured so that when the magnets 22, 112 are installed on the body 12 or mounting plate 114, the boundaries of the assembled components adds minimally to the attaching surface on the steel strap.

It will also be appreciated by those skilled in the art that the present device to secure steel strap when being are cut provides significant and substantial advantages over known and presently used systems. For example, the magnets 22, 112 allow the device 10, 110, 200 to be secured on the steel strap S at varying angles so as to maximize the holding power of the magnets 22, 112. This allows for easily positioning the device 10, 110, 200 on loads L at angles that may otherwise be difficult to access or to maneuver the device 10, 110, 200, for example, on uneven or irregular steel strap S surfaces.

Further, the device 10, 110, 200 can be used to readily secure the cut ends E of strap S by a single worker without the assistance of others and operated with less labor than known systems.

Other features of the present device that will be appreciated by those skilled in the art include faster operating time of the device; that is, the device can be quickly secured, reoriented, and removed without intricate installation or disengagement.

The materials of the body or mounting plate can also vary depending upon the anticipated use.

In the present disclosure, the words “a” or “an” are to be taken to include both the singular and the plural. Conversely, any reference to plural items shall, where appropriate, include the singular. It will be appreciated by those skilled in the art that the relative directional terms such as upper, lower, rearward, forward and the like are for explanatory purposes only and are not intended to limit the scope of the disclosure. All patents and published applications referred to herein are incorporated by reference in their entirety, whether or not specifically done so within the text of this disclosure.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

What is claimed is:

1. A device to secure and restrain ends of a steel strap positioned and tensioned around a load when the strap is cut, the device comprising:
a body having a non-linear shape and defining first and second legs opposing each other; and
first and second magnets mounted to the respective first and second legs at about ends thereof, wherein each of the magnets is loosely mounted on their respective legs for movement independent of each other.

2. The device of claim 1, wherein the body includes slotted openings on each leg, and wherein the magnets move along the slotted openings.

3. The device of claim 2, further including a stud mounted to each magnet, the studs positioned in respective slotted openings to permit the magnets to move along the slotted openings.

4. The device of claim 3, wherein the studs are threaded and further including nuts threaded on the studs to loosely secure the magnets to the tool body.

5. The device of claim 1, wherein the body has a horseshoe or omega-like shape.

6. A device to secure and restrain an end of a steel strap positioned and tensioned around a load when the strap is cut, the device comprising:
a mounting plate;
a magnet loosely mounted to a side of the mounting plate; and
a handle positioned on an opposite side of the mounting plate.

7. The device of claim 6, further including a stud mounted to the magnet, the stud through the mounting plate and secure on an opposite side of the mounting plate.

8. The device of claim 7, wherein the handle is mounted to the stud to loosely secure the magnet to the mounting plate.

9. The device of claim 8 wherein the magnet is free floating relative to the mounting plate.
